(19) United States
(12) Patent Application Publication
(10) Pub. No.: US 2004/0239793 A1
(43) Pub. Date: Dec. 2, 2004

(54) OPTICAL MODULE FOR A DIGITAL CAMERA

(76) Inventors: Cheng-Hsien Lu, Taipei Hsien (TW); Chih-Po Yang, Taipei City (TW)

Correspondence Address: NAIPO (NORTH AMERICA INTERNATIONAL PATENT OFFICE), P.O. BOX 506, MERRIFIELD, VA, 22116, US

(21) Appl. No.: 10/709,714

(22) Filed: May 24, 2004

(30) Foreign Application Priority Data
May 28, 2003 (TW) 092209827

(51) Int. Cl. H04N 5/225

(52) U.S. Cl. 348/340

(57) ABSTRACT

An optical module for a digital camera includes a substrate, a light sensor installed on the substrate for sensing light, a lens holder mounted on the light sensor, a light shield disposed in a position between a top surface of the substrate and a bottom end of the lens holder, a lens installed on the lens holder for focusing light onto the light sensor, at least a fixing device, such as a screw, and at least a buffering cushion installed on a position between a top part of the screw and the substrate for reducing the impact of the top part against the substrate. The light sensor of the optical module only receives light transmitted from the lens.

### BACKGROUND OF INVENTION

1. Field of the Invention

The present invention relates to a digital camera, and more particularly, to an optical module of the digital camera for receiving light coming from a lens of the optical module only. The optical module further comprises a cushion for reducing impact of a fixing device reducing a substrate of the optical module.

2. Description of the Prior Art

In recent years, the rapid development the Internet has had a remarkable influence on digital cameras. A user of a digital camera can transmit images captured by the digital camera to a friend via the Internet. A digital camera comprises a lens and a light sensor to capture images. The digital camera has to have the lens and the light sensor fabricated precisely, that is the lens having a light axis parallel to a normal line of the light sensor, to provide high-quality images.

Please refer to FIG. 1 and FIG. 2. FIG. 1 is a front view diagram of a digital camera 10 according to the prior art. FIG. 2 is a cross sectional diagram along a line X-X of the digital camera 10 shown in FIG. 1 according to the prior art. The digital camera 10 comprises a housing 12 and an optical module 13. The optical module 13 comprises a printed circuit board 14 installed inside the housing 12, a complementary metal oxide semiconductor sensor (CMOS sensor) as a light sensor 16 installed on the printed circuit board 14, a lens holder 18 mounted on the sensor 16, and a lens 20 installed on the lens holder 18. The lens 20 focuses light coming from an image that the digital camera 10 captures onto the CMOS sensor 16. The CMOS sensor 16 transforms the light transmitted from the lens 20 into electronic signals and transmits the electronic signals to electronic components, such as a CPU, on the printed circuit board 18 via the printed circuit board 18 for further manipulation.

When the lens holder 18 of the digital camera 10 is precisely positioned on the CMOS sensor 16, the lens 20 has a light axis 22 parallel to a normal line 24 of the CMOS sensor 16. Since the lens holder 18 of the digital camera 10 is positioned on the CMOS sensor 16 only in an interfering manner, the digital camera 10 probably displaces the lens holder 18 if hit or shook. That is, the light axis 22 of the lens holder 18 can become not parallel to the normal line 24 of the CMOS sensor 16, reducing the quality of an image captured by the digital camera 10. In addition, since the optical module 13 is not disposed adjacent to the printed circuit board 14, light outside of the optical module 13 can travel into the optical module 13 and project onto the CMOS sensor 16 not only through lens 20 but also through a gap between the optical module 13 and the printed circuit board 14, therefore affecting the operation of the CMOS sensor 16.

Please refer to FIG. 3 and FIG. 4. FIG. 3 is a front view diagram of a digital camera 30 according to the prior art. FIG. 4 is a cross sectional diagram along a line Y-Y of the digital camera 30 according to the prior art. The digital camera 30 has a structure similar to that of the digital camera 10. The only difference is that the digital camera 30 comprises a CMOS sensor 36, a printed circuit board 34 and an optical module 33 having a lens holder 38 disposed adjacent to the printed circuit board 34. In such a scenario, light outside of the optical module 33 will not travel into the optical module 33 through a virtual gap (no gap in fact) between the lens holder 38 and the printed circuit board 34. However, since the lens holder 38 is also mounted on the CMOS sensor 36 in the interfering manner, any impact on the digital camera 30 will likely affect the positions of the lens holder 38 and the CMOS sensor 36.

Please refer to FIG. 5 and FIG. 6. FIG. 5 is a front view diagram of a digital camera 50 according to the prior art. FIG. 6 is a cross sectional diagram along a line Z-Z of the digital camera 50 according to the prior art. The digital camera 50 has a structure similar to that of the digital camera 30. The only difference is that the digital camera 50 further comprises a fixing device 68 such as screws fastened into a printed circuit board 54 fixing a lens holder 58 to the printed circuit board 54. In such a scenario, not only does light outside of an optical module 53 not travel into the optical module through a virtual gap (no gap if fact) between the lens holder 58 and the printed circuit board 54, but also any impact on the digital camera 50 will not affect the positions of the lens holder 58 and the CMOS sensor 56.

In the digital camera 50, it is assumed that a lens 60 has a light axis 62 parallel to a normal line 64 of the CMOS sensor 56. However, in processes of fabrication and assembly of the digital camera 50, some unexpected factors affect the orientations of the light axis 62 and the normal line 64. For example, in the process of fabrication of the optical module 53, since the printed circuit board 54 typically passes through a heating apparatus like a reflow oven, heat generated by the reflow oven can deform the printed circuit board 54. Slight deformation of the printed circuit board 54 keeps the lens holder 58, which is disposed adjacent to the printed circuit board 54, from precisely aligning with the CMOS sensor 56.

In addition to deformation of the printed circuit board 54 unexpected factors further comprise varied-sized solder balls for electrically connecting the CMOS sensor 56 to the printed circuit board 54. Please refer to FIG. 7, which is a schematic diagram of a cross section of the digital camera 50 according to the prior art. The CMOS sensor 56 connects to the printed circuit board 54 with a plurality of solder balls 59 of a variety of sizes. As shown in FIG. 7, since the solder balls 59 have a variety of sizes, while the lens holder 58 is mounting onto the CMOS sensor 56, the lens holder 58 has a end, indicated by arrow A, that is nearer the printed circuit board 54 than another end, indicated by arrow B. After the fixing device 68 fixes the lens holder 58 to the printed circuit board 54, the light axis 62 of the lens 60 is therefore not parallel to the normal line 64 of the CMOS sensor 56.

Furthermore, even if the printed circuit board 54 does not suffer deformation or the solder balls 59 are of an identical size, other alignment problems can arise. For example, while the screws 68 are installed to fix the lens holder 58 to the printed circuit board 54, impact of the screws 68 against the printed circuit board 54 can affect the position of the lens holder 58 and the CMOS sensor 56, thus inevitably degrading the performance of the digital camera 50.

### SUMMARY OF INVENTION

It is therefore a primary objective of the claimed invention to provide an optical module for a digital camera, the optical module receiving light from a lens of the optical module only, to overcome the drawback of the prior art of light penetrating a gap between a lens holder and a substrate into the optical module.

It is another objective of the claimed invention to provide an optical module for a digital camera, the optical module having a cushion for reducing impact of a fixing device against a substrate of the optical module, to overcome the drawback of the prior art of either mounting a lens holder onto a light sensor precisely or fixing the lens holder to a substrate tightly at the same time.

According to the claimed invention, the optical module comprises a substrate, a light sensor installed on the substrate for sensing light, a lens holder mounted on the light sensor, a light shield disposed at a position between a top surface of the substrate and a bottom end of the lens holder, and a lens installed on the lens holder for focusing light onto the light sensor.

The light module further comprises at least a fixing device fastened to the substrate for fixing the lens holder to the substrate, and at least a cushion disposed between the fixing device and the substrate for reducing impact of the fixing device against the substrate.

The cushion has an elastic constant smaller than that of the light shield.

It is an advantage of the claimed invention that an optical module, with the light shield and the cushion, is capable of not only preventing light outside of the optical module from traveling through a gap between the lens holder and the substrate into the optical module, but also both reducing impact of the fixing device against the substrate and allowing mounting of the lens holder onto the light sensor. In addition, since the cushion has a smaller elastic constant than the light shield, the problem of solder balls of varying sizes does not affect the performance of the digital camera.

These and other objectives of the claimed invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a front view diagram of a digital camera according to the prior art.

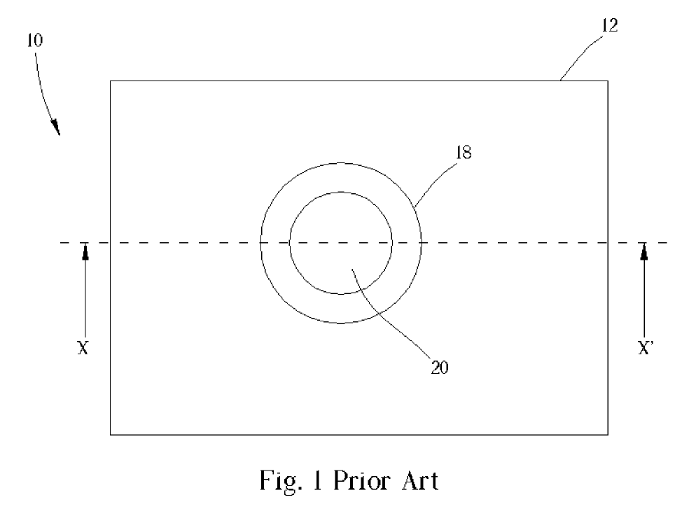

FIG. 2 is a cross sectional diagram along a line X-X of the digital camera shown in FIG. 1 according to the prior art.

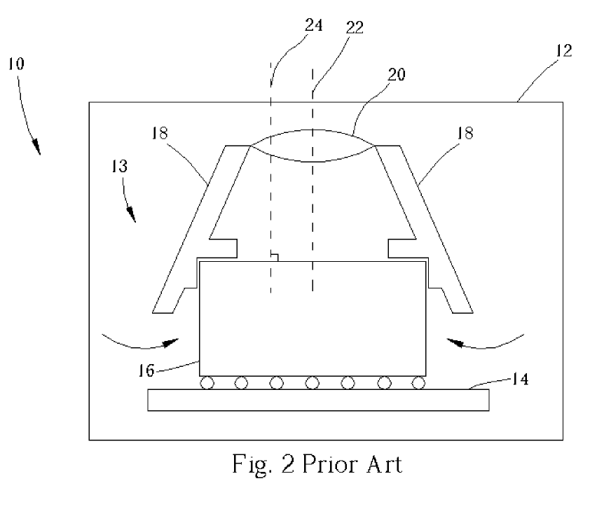

FIG. 3 is a front view diagram of a second digital camera according to the prior art.

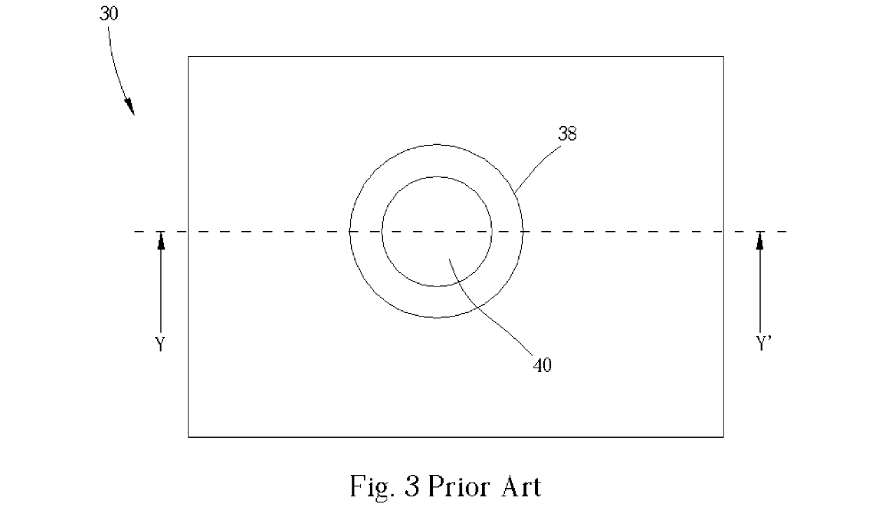

FIG. 4 is a cross sectional diagram along a line Y-Y of the digital camera shown in FIG. 3 according to the prior art.

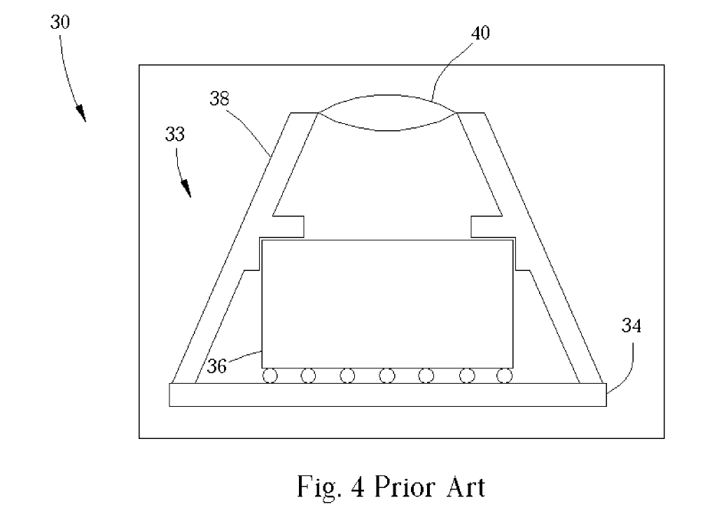

FIG. 5 is a front view diagram of a third digital camera according to the prior art.

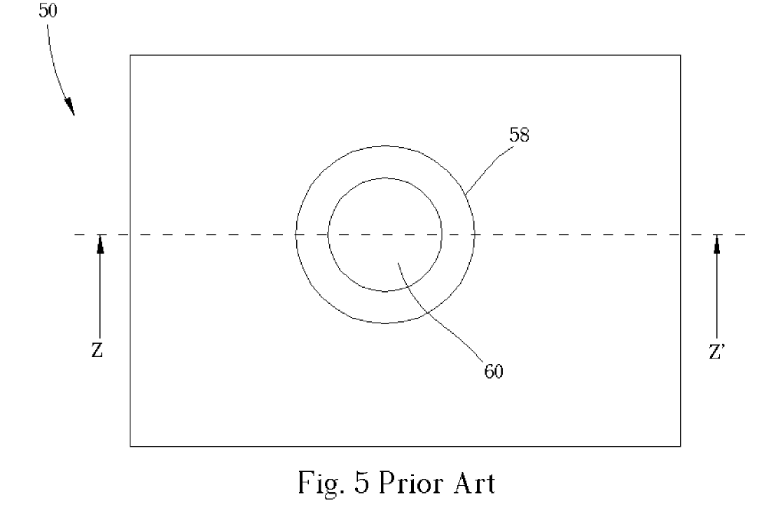

FIG. 6 is a cross sectional diagram along a line Z-Z of the digital camera shown in FIG. 1 according to the prior art.

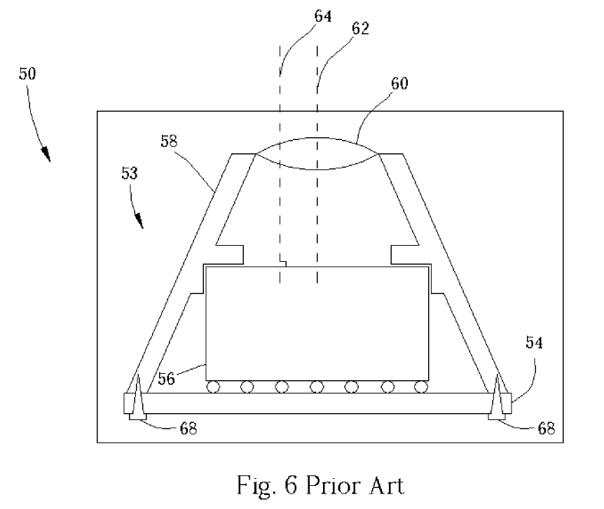

FIG. 7 is a second cross sectional diagram of the digital camera shown in FIG. 5 according to the prior art.

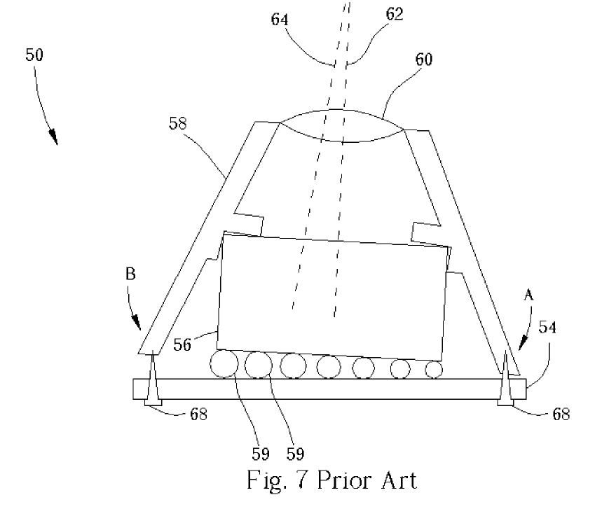

FIG. 8 is a front view diagram of a preferred embodiment of a digital camera according to the present invention.

FIG. 9 is a schematic of a cross section along a line W-W of the digital camera shown in FIG. 8 according to the present invention.

FIG. 10 is a schematic diagram of a second embodiment of an optical module according to the present invention.

### DETAILED DESCRIPTION

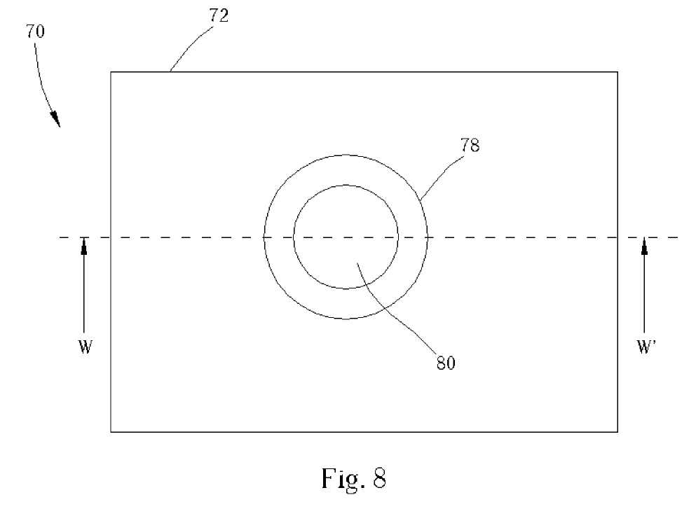

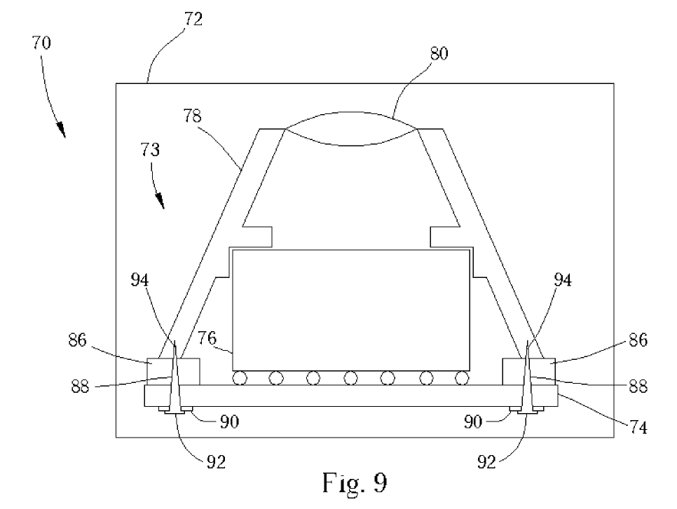

Please refer to FIG. 8 and FIG. 9. FIG. 8 is a front view diagram of a preferred embodiment of a digital camera 70 according to the present invention. FIG. 9 is a schematic of a cross section along a line W-W of the digital camera 70 according to the present invention. The digital camera 70 comprises a housing 72, and an optical module 73. The optical module 73 comprises a substrate 74 such as a printed circuit board installed inside the housing 72, a light sensor 76 such as a CMOS sensor installed on the substrate 74, a lens holder 78 mounted onto the light sensor 76, and a lens 80 installed on the lens holder 78. The lens 80 focuses light coming from an image that the digital camera 70 captures onto the light sensor 76. The light sensor 76 transforms the light from the lens 80 into electronic signals and transmits the electronic signals to electronic components, such as a CPU, on the printed circuit board 74 via the printed circuit board 74 for further manipulation.

Please note that the lens holder 78 is disposed away from the substrate 74 by a predetermined distance, similar to the disposition of the lens holder 18 and substrate 14 of the optical module 13. The optical module 73 further comprises a resilient light shield 86, such as a rubber pad, disposed at a position between a top surface of the substrate 74 and a bottom end of the lens holder 78 for preventing light outside of the optical module from traveling through a virtual gap (no gap in fact) between the lens holder 78 and the substrate 74 into the optical module 73. The light shield 86 has a thickness slightly larger than the predetermined distance and causes the light sensor 76 to receive nothing but the light from the lens 80.

The optical module 73 further comprises a fixing device for fixing the lens holder 78 to the substrate 74. In the preferred embodiment, the fixing device comprises at least a screw 88 for fixing the lens holder 78 to the substrate 74 by penetrating the cushion 90 and corresponding apertures (not shown) on the substrate 74 and into corresponding screw holes 94 on the lens holder 78, and at least a cushion 90 disposed between a head 92 of the screw 88 and the substrate 74 for reducing impact of the head 92 against the substrate 74. The head 92 squeezes the cushion 90 into a position between the head 92 and the substrate 74, the squeezed cushion 90 capable of preventing misalignment between the lens 80 and the light sensor 76 due to the impact of the head 92 of the screw 88 against the substrate 74.

The cushion 90 can be made from resilient material like rubber for example or be composed of at least a spring. The cushion 90 can have a structure of an integrated ring or multiple pieces comprising a plurality of cushion cells. Note that no matter what material the cushion 90 is made from or what structure it has, the cushion 90 must be designed to have a specific form corresponding to the screw hole 94 of the lens holder 78. That is, if the lens holder 78 has four screw holes 94 and the fixing device has four screws 88, the cushion 90 of the multiple-pieced structure has to comprise at least four cushion cells, each of the cushion cells installed between the head 92 of the screw 88 and the aperture on the substrate 74 corresponding to the screw 88.

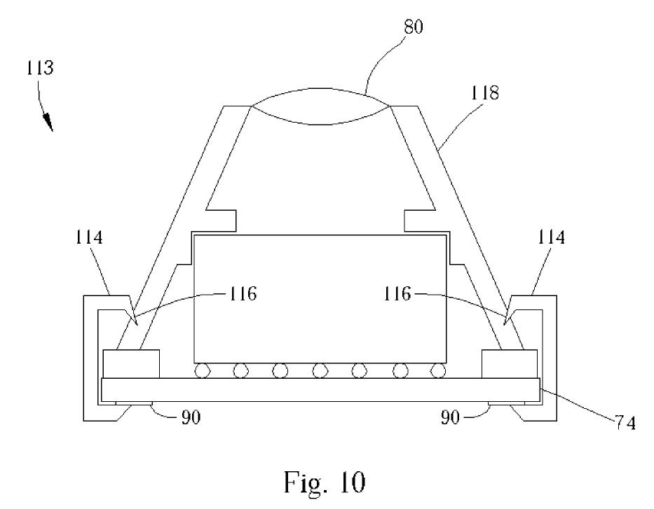

The fixing device for fixing the lens holder 78 to the substrate 74 can also be an elastic hook. Please refer to FIG. 10, which is a schematic diagram of a second embodiment of an optical module 113 according to the present invention. The optical module 113 has a structure similar to that of the optical module 70. The only difference is that the optical device 113 comprises the fixing device of a plurality of elastic hooks 114, each of the hooks 114 having two ends for hooking a slot 116 installed on a lens holder 118 of the optical module 113 and the cushion 90 disposed under the substrate 74 respectively. If the cushion 90 includes four cushion cells, the elastic hook 114 comprises, of course, four corresponding hook units.

In order to ensure that the lens holder 78 of the optical module 70 or 113 is fixed to the substrate 74 steadily and the lens 80 has a light axis parallel to a normal line of the CMOS sensor 76, the light shield 86 is designed to have an elastic constant smaller than that of the cushion 90. Therefore, even if the light axis of the lens 80 is not initially parallel to the normal line of the CMOS sensor 76 because of unexpected factors, such as a bent printed circuit board 74 or solder balls of a variety of sizes, a difference of elastic constants of the cushion 90 and the light shield 86 provides a way for the light axis of the lens 80 to be adjusted to be parallel to the normal line of the CMOS sensor 76.

In contrast to the prior art, the present invention provides the optical modules 73 and 113, both of which comprise the light shield 86 capable of preventing the CMOS sensor 76 from receiving light from a gap between the lens holder 78 and the substrate 74 to improve the quality of images captured by the optical module. In addition, the optical module 73 (or 113) further comprises the cushion 90 disposed between the fixing device 88 and the substrate 74 for buffering impact of the fixing device 88 against the substrate 74 in a process of fixing the fixing device 88 to the substrate 74. Moreover, since the light shield 86 has the elastic constant smaller than that of the cushion, the lens 80 and the CMOS sensor 76 are still well positioned despite unexpected factors, such as a deformed printed circuit board or non-uniform solder ball sizes.

Following the detailed description of the present invention above, those skilled in the art will readily observe that numerous modifications and alterations of the device may be made while retaining the teachings of the invention. Accordingly, the above disclosure should be construed as limited only by the metes and bounds of the appended claims.

What is claimed is:

1. An optical module for a digital camera, the optical module comprising:
a substrate;
a light sensor installed on the substrate for sensing light;
a lens holder mounted on the light sensor;
a light shield disposed at a position between a top surface of the substrate and a bottom end of the lens holder; and
a lens installed on the lens holder for focusing light onto the light sensor.

2. The optical module of claim 1, wherein the light shield is resilient.

3. The optical module of claim 2, wherein the light shield is a rubber pad.

4. The optical module of claim 1 further comprising at least a fixing device fastened into the substrate and fixing the lens holder to the substrate.

5. The optical module of claim 4, wherein the fixing device is a screw.

6. The optical module of claim 4, wherein the fixing device comprises an elastic hook.

7. The optical module of claim 4 further comprising at least a cushion disposed between the fixing device and the substrate for reducing impact of the fixing device against the substrate.

8. The optical module of claim 7, wherein the cushion is made from rubber.

9. The optical module of claim 7, wherein the cushion comprises at least a spring.

10. The optical module of claim 1, wherein the light sensor is a complementary metal oxide semiconductor (CMOS) sensor and the substrate is a printed circuit board.

11. An optical module for a digital camera, the optical module comprising:
a substrate;
a light sensor installed on the substrate for sensing light;
a lens holder mounted on the light sensor;
a fixing device fastened into the substrate and fixing the lens holder to the substrate;
a cushion installed between the fixing device and the substrate for reducing impact of the fixing device against the substrate; and
a lens installed on the lens holder for focusing light onto the light sensor.

12. The optical module of claim 11, wherein the cushion is made from rubber.

13. The optical module of claim 11, wherein the cushion comprises at least a spring.

14. The optical module of claim 11, wherein the fixing device is a screw.

15. The optical module of claim 11, wherein the fixing device comprises an elastic hook.

16. The optical module of claim 11 further comprising a light shield disposed at a position between a top surface of the substrate and a bottom end of the lens holder.

17. The optical module of claim 16, wherein the light shield is resilient.

18. The optical module of claim 17, wherein the light shield is a rubber pad.

19. The optical module of claim 11, wherein the light sensor is a CMOS sensor and the substrate is a printed circuit board.

20. The optical module of claim 16, where the cushion has an elastic constant smaller than that of the light shield.
